(19) United States
(12) Patent Application Publication
(10) Pub. No.: US 2024/0220674 A1
(43) Pub. Date: Jul. 4, 2024

(54) CONVERGED MODEL BASED RISK ASSESSMENT AND AUDIT GENERATION

(71) Applicant: International Business Machines Corporation, Armonk, NY (US)

(72) Inventors: Melba Lopez Broz, Cedar Park, TX (US); Dimple Gajra, Austin, TX (US); Nikki Elyse Robinson, Davidsonville, MD (US); Raul Infantes, Miami, FL (US)

(73) Assignee: International Business Machines Corporation, Armonk, NY (US)

(21) Appl. No.: 18/090,144

(22) Filed: Dec. 28, 2022

(51) Int. Cl. G06F 30/20; G06F 21/57

(52) U.S. Cl. CPC G06F 30/20; G06F 21/577; G06F 2221/034

(57) ABSTRACT

Using a system risk evaluation model, system data is evaluated, the evaluating identifying a system risk, the system risk comprising a risk associated with a system of an organization being audited, the system risk evaluation model computing a system risk score using a first plurality of weights assigned to data attributes of the system data. Using a role risk evaluation model, role data is evaluated, the evaluating identifying a role risk, the role risk comprising a risk associated with a role in the organization being audited, the role risk evaluation model comprising computing a role risk score using a second plurality of weights assigned to data attributes of the role data. Using an audit repository, an audit customized to the system risk and the role risk is generated. Using a result of the audit, a configuration of the system is caused to be adjusted.

### BACKGROUND

The present invention relates generally to a method, system, and computer program product for risk assessment. More particularly, the present invention relates to a method, system, and computer program product for converged model based risk assessment and audit generation.

A risk assessment is an analysis process that determines likelihoods of possible mishaps, consequences if a mishap occurs, and tolerances for mishaps. The results of a risk assessment can be used to inform decisions on which risks to mitigate and how to mitigate them cost-effectively. For example, a risk assessment might be used to determine that a likelihood of computer system A's failure within the next week is 20%, and if system A does fail the business that owns the system will be unable to process payroll for its employees. Thus, the business determines that failure of this computer system is unacceptable, and deploys a duplicate for system A so that if the predicted failure occurs, the duplicate will still be available and the impact to the business will be minimal.

An audit is a review of compliance with a regulation, guideline, technical standard, or the like. For example, Payment Card Industry (PCI) compliance refers to compliance with technical and operational standards that businesses follow to secure and protect credit card data provided by cardholders and transmitted through card processing transactions, helping ensure the security of credit card transactions in the payments industry. Card processing agreements require that organizations that process credit card information maintain PCI compliance. Thus, a PCI compliance audit is a review of merchants that process credit card transactions to make sure that they are compliant with PCI data security standards. As another example, the European Union's (EU) General Data Protection Regulation (GDPR) is a privacy and security law that imposes obligations onto organizations anywhere, so long as they target or collect data related to people in the EU. Thus, organizations subject to the GDPR typically audit their GPDR compliance, either through a self-assessment or by having a third party perform the audit.

### SUMMARY

The illustrative embodiments provide a method, system, and computer program product. An embodiment includes a method that evaluates, using a system risk evaluation model, system data, the evaluating identifying a system risk, the system risk comprising a risk associated with a system of an organization being audited, the system risk evaluation model computing a system risk score using a first plurality of weights assigned to data attributes of the system data. An embodiment evaluating, using a role risk evaluation model, role data, the evaluating identifying a role risk, the role risk comprising a risk associated with a role in the organization being audited, the role risk evaluation model comprising computing a role risk score using a second plurality of weights assigned to data attributes of the role data. An embodiment generates, using an audit repository, an audit customized to the system risk and the role risk. An embodiment causing adjusting, using a result of the audit, a configuration of the system.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for converged model based risk assessment and audit generation in accordance with an illustrative embodiment;

FIG. 3 depicts an example of converged model based risk assessment and audit generation in accordance with an illustrative embodiment;

FIG. 4 depicts a continued example of converged model based risk assessment and audit generation in accordance with an illustrative embodiment;

FIG. 5 depicts a continued example of converged model based risk assessment and audit generation in accordance with an illustrative embodiment;

FIG. 6 depicts a continued example of converged model based risk assessment and audit generation in accordance with an illustrative embodiment;

FIG. 7 depicts a flowchart of an example process for converged model based risk assessment and audit generation in accordance with an illustrative embodiment.

### DETAILED DESCRIPTION

The illustrative embodiments recognize that, the larger and more complex an organization becomes, the harder assessing risks to the organization becomes. For example, as an organization adds employees, it becomes harder to assess which employees are key contributors who would affect the entire organization if they changed employment or were unable to work. As another example, as an organization adds products and product lines, it becomes harder to assess how risks to a particular product affect the entire organization.

The illustrative embodiments also recognize that risk assessments and audits are often static, or are based on outdated assumptions or configurations, adding to the difficulty. For example, an organization might have migrated its data processing from a server in the organization's basement to a cloud configuration hosted by a service provider, changing the organization's risk exposure, or an organization might have expanded from the United States into an EU country, subjecting the organization to GDPR requirements. A risk assessment that does not take these changes into account will be incomplete, and thus ineffective. As well, risk assessments are often siloed, for example assessing a product without taking into account people working on the product or risks that might have been identified from similar products. In addition, humans assessing risks and doing audits are often insufficiently systematic and are prone to biases and other errors. Thus, the illustrative embodiments recognize that there is a need to improve risk assessments and audits.

The illustrative embodiments recognize that the presently available tools or solutions do not address these needs or provide adequate solutions for these needs. The illustrative embodiments used to describe the invention generally address and solve the above-described problems and other problems related to converged model based risk assessment and audit generation.

An embodiment can be implemented as a software application. The application implementing an embodiment can be configured as a modification of an existing automated risk assessment or audit generation system, as a separate application that operates in conjunction with an existing automated risk assessment or audit generation system, a standalone application, or some combination thereof.

Particularly, some illustrative embodiments provide a method that uses a system risk evaluation model to evaluate system data and identify a system risk, uses a role risk evaluation model to evaluate role data and identify a role risk, and generates, using an audit repository, an audit customized to the system risk and the role risk.

An embodiment receives system data, which is data relating to a system or product. Some non-limiting examples of types, or attributes, of system data are a country associated with the system (e.g., where the system is located, sold in, or where parts used in manufacturing or maintaining the system come from), a system type (e.g., whether the system is a virtual machine host, application container, network switch, or in another classification), regulations associated with the system (e.g., PCI, GDPR, or United States law governing health care data), a data type processed by the system (e.g., privileged data, trade secret data, customer data, financial data), scores of particular cybersecurity or other risks (e.g., common vulnerabilities and exposures (CVE) common weakness enumeration (CWE), and vulnerability priority rating (VPR) in cybersecurity), the results of particular monitoring tools, and natural language data (e.g., social media communications, blogs, or alerts communicating a new or updated risk).

An embodiment uses a system risk evaluation model to evaluate system data and identify a system risk. A system risk is a risk associated with a particular system within an organization for which an audit is being prepared. The system risk evaluation model includes weights assigned to each of the input data attributes, to adjust the relative importance of the attributes. In one embodiment, the system risk evaluation model generates a score for a risk the model is configured to evaluate, and the embodiment identifies, as a system risk, a risk with a score above a threshold score. In another embodiment, the system risk evaluation model predicts that a score for a risk the model is configured to evaluate is increasing at above a threshold rate, or will be above a threshold score within a predetermined time, and the embodiment identifies this risk as a system risk. System risk evaluation models are presently available. For example, cybersecurity monitoring services monitor an organization's information technology infrastructure and related data to detect and mitigate cybersecurity risks.

An embodiment receives role data, which is data relating to people or their roles in an organization. Some non-limiting examples of types, or attributes, of role data are a job title (e.g., software architect or comptroller), a country associated with the role (e.g., where an employee is located or which country an employee is a citizen of), an employee's training (e.g., x86 assembly language or penetration testing for cybersecurity vulnerabilities), certifications an employee has earned (e.g., registered nurse or a certified privacy professional), the data an employee is permitted to access (e.g., tax identification numbers of other employees, or software source code), the data an employee is permitted to change (e.g., software source code of a project to which the employee is assigned but not source code of other projects to which the employee is not assigned), and assessments from an employee's manager (e.g., Person A is a key contributor on Project 1, while Person B has asked for a transfer to another group).

An embodiment uses a role risk evaluation model to evaluate role data and identify a role risk. A role risk is a risk associated with a particular person or role played by a person within an organization for which an audit is being prepared. The role risk evaluation model includes weights assigned to each of the input data attributes, to adjust the relative importance of the attributes. In one embodiment, the role risk evaluation model generates a score for a risk the model is configured to evaluate, and the embodiment identifies, as a role risk, a risk with a score above a threshold score. In another embodiment, the role risk evaluation model predicts that a score for a risk the model is configured to evaluate is increasing at above a threshold rate, or will be above a threshold score within a predetermined time, and the embodiment identifies this risk as a role risk. Role risk evaluation models are presently available. For example, role-based access control models assign a user to a role which has an associated set of permissions, and risk-aware role-based access control models compute a tradeoff between a risk of granting a permission and a likelihood of misuse of the granted permission.

An embodiment uses an identified system risk and the role risk evaluation model to identify a role risk related to the system risk. For example, if the system risk is System A, a related role risk might be a person associated with System A. One embodiment uses a set of rules or heuristics to identify a role risk related to the system risk. For example, one rule might state that a user with elevated privileges (e.g., administrator level rather than user level) on a system identified as a system risk is a related role risk. Another example rule might state that a new role, added to a system in correlation with a trigger of the identification as the system risk, is a related role risk. Other rules or heuristics are also possible and contemplated within the scope of the illustrative embodiments.

An embodiment uses an identified role risk and the system risk evaluation model to identify a system risk related to the role risk. For example, if the role risk is Person A, who works on System A, a related system risk might be System A.

An embodiment uses an identified system risk and the system risk evaluation model to identify one or more additional system risks related to the identified system risk. To identify additional system risks, an embodiment identifies a set of input data attributes having weights higher than a threshold weight, or the n highest-weighted input data attributes (n is a predetermined constant), in the system risk evaluation model used in determining the original system risk. Systems sharing the identified set of input data attributes are identified as additional system risks. For example, if the identified system risk is System A, a financial data processor based in the European Union, System B (also a financial data processor based in the European Union) might be an additional system risk due to data protection requirements applicable in the European Union, while System C (a health care data processor based in the United States, where the European Union data protection requirements do not apply) might not. (Note that because System C is a health care data processor based in the United States, and subject to United States health care data protection requirements, System C might have been identified as a system risk in its own right, but not related to System A's risk.)

An embodiment uses an identified role risk and the role risk evaluation model to identify one or more additional role risks related to the identified role risk. To identify additional role risks, an embodiment identifies a set of input data attributes having weights higher than a threshold weight, or the n highest-weighted input data attributes (n is a predetermined constant), in the role risk evaluation model used in determining the original role risk. Roles sharing the identified set of input data attributes are identified as additional role risks. For example, if the identified role risk is Person A, a lead software architect on System D. Person B (a lead software architect on System E) might be an additional system risk, while Person C (a lawyer with minimal interaction with System D) might not.

An embodiment receives audit data, which is data relating to an audit to be performed on an organization. Some non-limiting examples of types, or attributes, of audit data are the sector in which the organization operates (e.g., retail, healthcare, or education), the type of audit to be performed (e.g., PCI compliance, GPDR compliance, compliance with United States law governing health care data), types of systems to be audited (e.g., whether the system is a virtual machine host, application container, network switch, or in another classification), a type of cloud infrastructure the organization uses, and previous audit questions marked as passed or failed. Audit data may have been performed previously on peer industries or organizations and anonymized and used for comparison, prediction, and trend identification. An embodiment also receives, or has access to, a repository of audit questions that could be part of an audit, along with data attributes an audit question applies to. For example, PCI-related questions might apply to a credit card transaction system, but not a medical records system.

An embodiment generates an audit customized to the system risk and the role risk, using the repository of audit questions that could be part of an audit. In particular, an embodiment selects one or more audit questions by comparing data attributes an audit question applies to with one or more risks, or attributes of risks. For example, if the system risk is System A, a financial data processor based in the European Union and executing Application B, an embodiment might select audit questions related to System A, the executing version of Application B (as older versions tend to have a higher likelihood of exploitation and thus, increased risk), other software execution on System A, financial data processors, European Union-based systems, and the like. As another example, if the role risk is Person A, a lead software architect who has worked at her current employer for ten years, an embodiment might select audit questions related to Person A, lead software architects in general, and people who have worked at their current employer for eight to twelve years. The risks used are the identified system and role risks, as well as related or additional system or role risks.

One embodiment performs the generated audit, or a portion of the generated audit, automatically. For example, if a question in the audit asks whether people in a software architect role have access to an employee tax identification number database, an embodiment might create a test account with privileges copied from those of an existing software architect, then use the test account to attempt to access the database. As another example, if a question in the audit asks whether a version number of installed software is at or above a specified version number, an embodiment performs the verification. Another embodiment causes another system to perform the generated audit or a portion. Another embodiment provides the generated audit, or a portion, to a human expert for audit performance.

An embodiment adjusts, or causes adjusting, using a result of the audit, a configuration of the system for which the system risk was identified. For example, if a software application executing on the system was discovered to have a known vulnerability, an embodiment causes an update of the application to a version in which the vulnerability is repaired.

An embodiment uses one or more risks, as well as audit results if available, to update one or more of the system and role risk evaluation models. In particular, an embodiment updates weights of attributes used in determining a risk, then repeats the risk identification and audit generation process using the updated weights. One embodiment updates weights of attributes used in determining a risk in response to a policy change from another source. For example, a new privacy law in a jurisdiction may require additional data attributes used to assess compliance with the new law, or increased weights on existing data attributes used to assess compliance with the new law. Another embodiment updates weights of attributes used in determining a risk based on a characteristic of the data used to determine a risk. For example, if one data attribute is common to most or all of the data, this attribute is unlikely to be useful in identifying a risk and should have a lower weight than other, more useful attributes. Conversely, if one data attribute is well correlated to a particular risk, this attribute should have a higher weight than less useful attributes. Data analysis and statistical techniques for determining attribute commonality and correlation are presently available. Another embodiment updates weights of attributes used in determining a risk based on prior organization behaviors. For example, an embodiment might determine that, because every year for the past five an organization has tightened a policy related to known vulnerabilities, the embodiment performs a similar update this year, without waiting for the organization to do so. Another embodiment updates weights of attributes used in determining a risk based on industry or technology trends. For example, an embodiment might determine that additional risk is being reported in application container technologies hosted on a particular cloud computing service, and thus updates weights of attributes related to application container technologies, the particular cloud computing service, or cloud computing services in general.

The manner of converged model based risk assessment and audit generation described herein is unavailable in the presently available methods in the technological field of endeavor pertaining to automated risk assessment and management. A method of an embodiment described herein, when implemented to execute on a device or data processing system, comprises substantial advancement of the functionality of that device or data processing system in using a system risk evaluation model to evaluate system data and identify a system risk, using a role risk evaluation model to evaluate role data and identify a role risk, and generating, using an audit repository, an audit customized to the system risk and the role risk.

The illustrative embodiments are described with respect to certain types of system data attributes, role data attributes, audit data attributes, risks, audits, risk evaluation models, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

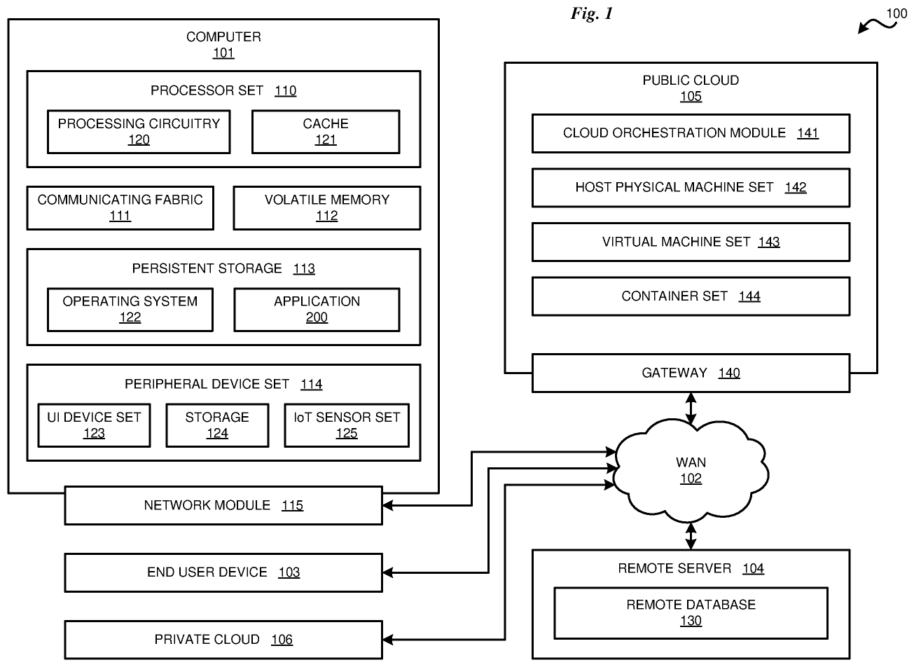

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a converged model based risk assessment and audit generation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IOT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

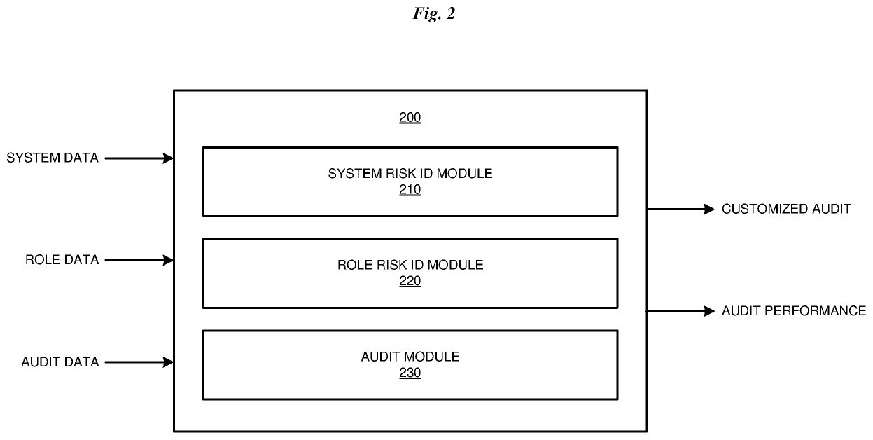

With reference to FIG. 2, this figure depicts a block diagram of an example configuration for converged model based risk assessment and audit generation in accordance with an illustrative embodiment. Application 200 is the same as application 200 in FIG. 1.

Application 200 receives system data, which is data relating to a system or product. Some non-limiting examples of types, or attributes, of system data are a country associated with the system (e.g., where the system is located, sold in, or where parts used in manufacturing or maintaining the system come from), a system type (e.g., whether the system is a virtual machine host, application container, network switch, or in another classification), regulations associated with the system (e.g., PCI, GDPR, or United States law governing health care data), a data type processed by the system (e.g., privileged data, trade secret data, customer data, financial data), scores of particular cybersecurity or other risks (e.g., common vulnerabilities and exposures (CVE) common weakness enumeration (CWE), and vulnerability priority rating (VPR) in cybersecurity), the results of particular monitoring tools, and natural language data (e.g., social media communications, blogs, or alerts communicating a new or updated risk).

System risk identification (ID) module 210 uses a system risk evaluation model to evaluate system data and identify a system risk. A system risk is a risk associated with a particular system within an organization for which an audit is being prepared. The system risk evaluation model includes weights assigned to each of the input data attributes, to adjust the relative importance of the attributes. In one implementation of module 210, the system risk evaluation model generates a score for a risk the model is configured to evaluate, and module 210 identifies, as a system risk, a risk with a score above a threshold score. In another implementation of module 210, the system risk evaluation model predicts that a score for a risk the model is configured to evaluate is increasing at above a threshold rate, or will be above a threshold score within a predetermined time, and module 210 identifies this risk as a system risk.

Application 200 receives role data, which is data relating to people or their roles in an organization. Some non-limiting examples of types, or attributes, of role data are a job title (e.g., software architect or comptroller), a country associated with the role (e.g., where an employee is located or which country an employee is a citizen of), an employee's training (e.g., x86 assembly language or penetration testing for cybersecurity vulnerabilities), certifications an employee has earned (e.g., registered nurse or a certified privacy professional), the data an employee is permitted to access (e.g., tax identification numbers of other employees, or software source code), the data an employee is permitted to change (e.g., software source code of a project to which the employee is assigned but not source code of other projects to which the employee is not assigned), and assessments from an employee's manager (e.g., Person A is a key contributor on Project 1, while Person B has asked for a transfer to another group).

Role risk identification (ID) module 220 uses a role risk evaluation model to evaluate role data and identify a role risk. A role risk is a risk associated with a particular person or role played by a person within an organization for which an audit is being prepared. The role risk evaluation model includes weights assigned to each of the input data attributes, to adjust the relative importance of the attributes. In one implementation of module 220, the role risk evaluation model generates a score for a risk the model is configured to evaluate, and module 220 identifies, as a role risk, a risk with a score above a threshold score. In another implementation of module 220, the role risk evaluation model predicts that a score for a risk the model is configured to evaluate is increasing at above a threshold rate, or will be above a threshold score within a predetermined time, and module 220 identifies this risk as a role risk. Role risk evaluation models are presently available. For example, role-based access control models assign a user to a role which has an associated set of permissions, and risk-aware role-based access control models compute a tradeoff between a risk of granting a permission and a likelihood of misuse of the granted permission.

Module 220 uses an identified system risk and the role risk evaluation model to identify a role risk related to the system risk. For example, if the system risk is System A, a related role risk might be a person associated with System A.

Module 210 uses an identified role risk and the system risk evaluation model to identify a system risk related to the role risk. For example, if the role risk is Person A, who works on System A, a related system risk might be System A. One implementation of module 210 uses a set of rules or heuristics to identify a role risk related to the system risk. For example, one rule might state that a user with elevated privileges (e.g., administrator level rather than user level) on a system identified as a system risk is a related role risk. Another example rule might state that a new role, added to a system in correlation with a trigger of the identification as the system risk, is a related role risk. Other rules or heuristics are also possible.

Module 210 uses an identified system risk and the system risk evaluation model to identify one or more additional system risks related to the identified system risk. To identify additional system risks, module 210 identifies a set of input data attributes having weights higher than a threshold weight, or the n highest-weighted input data attributes (n is a predetermined constant), the system risk evaluation model used in determining the original system risk. Systems sharing the identified set of input data attributes are identified as additional system risks. For example, if the identified system risk is System A, a financial data processor based in the European Union, System B (also a financial data processor based in the European Union) might be an additional system risk due to data protection requirements applicable in the European Union, while System C (a health care data processor based in the United States) might not. (Note that because System C is a health care data processor based in the United States, and subject to United States health care data protection requirements, System C might have been identified as a system risk in its own right, but not related to System A's risk.)

Module 220 uses an identified role risk and the role risk evaluation model to identify one or more additional role risks related to the identified role risk. To identify additional role risks, module 220 identifies a set of input data attributes having weights higher than a threshold weight, or the n highest-weighted input data attributes (n is a predetermined constant), the role risk evaluation model used in determining the original role risk. Roles sharing the identified set of input data attributes are identified as additional role risks. For example, if the identified role risk is Person A, a lead software architect on System D. Person B (a lead software architect on System E) might be an additional system risk, while Person C (a lawyer with minimal interaction with System D) might not.

Audit module 230 receives audit data, which is data relating to an audit to be performed on an organization. Some non-limiting examples of types, or attributes, of audit data are the sector in which the organization operates (e.g., retail, healthcare, or education), the type of audit to be performed (e.g., PCI compliance, GPDR compliance, compliance with United States law governing health care data), types of systems to be audited (e.g., whether the system is a virtual machine host, application container, network switch, or in another classification), a type of cloud infrastructure the organization uses, and previous audit questions marked as passed or failed. Audit data may have been performed previously on peer industries or organizations and anonymized and used for comparison, prediction, and trend identification. Module 230 also receives, or has access to, a repository of audit questions that could be part of an audit, along with data attributes an audit question applies to. For example, PCI-related questions might apply to a credit card transaction system, but not a medical records system.

Audit module 230 generates an audit customized to the system risk and the role risk, using the repository of audit questions that could be part of an audit. In particular, module 230 selects one or more audit questions by comparing data attributes an audit question applies to with one or more risks, or attributes of risks. For example, if the system risk is System A, a financial data processor based in the European Union and executing Application B, module 230 might select audit questions related to System A, the executing version of Application B (as older versions tend to have a higher likelihood of exploitation and thus, increased risk), other software execution on System A, financial data processors, European Union-based systems, and the like. As another example, if the role risk is Person A, a lead software architect who has worked at her current employer for ten years, module 230 might select audit questions related to Person A, lead software architects in general, and people who have worked at their current employer for eight to twelve years. The risks used are the identified system and role risks, as well as related or additional system or role risks.

Audit module 230 performs the generated audit, or a portion of the generated audit, automatically. For example, if a question in the audit asks whether people in a software architect role have access to an employee tax identification number database, module 230 might create a test account with privileges copied from those of an existing software architect, then use the test account to attempt to access the database. As another example, if a question in the audit asks whether a version number of installed software is at or above a specified version number, module 230 performs the verification. Another implementation of module 230 causes another system to perform the generated audit or a portion. Another implementation of module 230 provides the generated audit, or a portion, to a human expert for performance.

Application 200 adjusts, or causes adjusting, using a result of the audit, a configuration of the system for which the system risk was identified. For example, if a software application executing on the system was discovered to have a known vulnerability, application 200 causes an update of the application to a version in which the vulnerability is repaired.

Module 230 uses one or more risks, as well as audit results if available, to update one or more of the system and role risk evaluation models. In particular, module 230 updates weights of attributes used in determining a risk, then repeats the risk identification and audit generation process using the updated weights. One implementation of module 230 updates weights of attributes used in determining a risk in response to a policy change from another source. For example, a new privacy law in a jurisdiction may require additional data attributes used to assess compliance with the new law, or increased weights on existing data attributes used to assess compliance with the new law. Another implementation of module 230 updates weights of attributes used in determining a risk based on a characteristic of the data used to determine a risk. For example, if one data attribute is common to most or all of the data, this attribute is unlikely to be useful in identifying a risk and should have a lower weight than other, more useful attributes. Conversely, if one data attribute is well correlated to a particular risk, this attribute should have a higher weight than less useful attributes. Data analysis and statistical techniques for determining attribute commonality and correlation are presently available. Another implementation of module 230 updates weights of attributes used in determining a risk based on prior organization behaviors. For example, an embodiment might determine that, because every year for the past five an organization has tightened a policy related to known vulnerabilities, the implementation performs a similar update this year, without waiting for the organization to do so. Another implementation of module 230 updates weights of attributes used in determining a risk based on industry or technology trends. For example, the implementation might determine that additional risk is being reported in application container technologies hosted on a particular cloud computing service, and thus updates weights of attributes related to application container technologies, the particular cloud computing service, or cloud computing services in general.

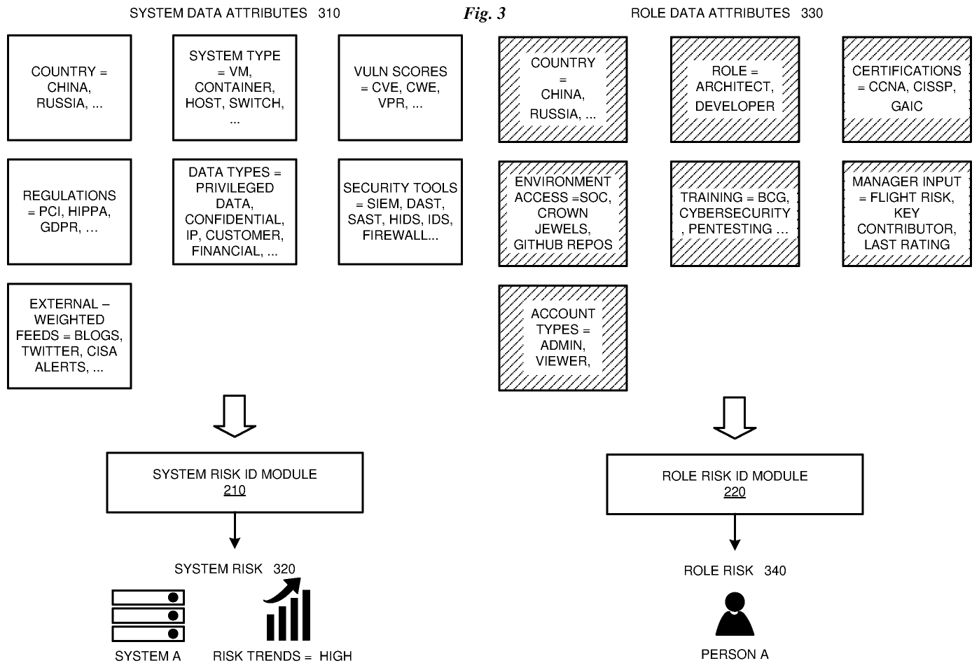

With reference to FIG. 3, this figure depicts an example of converged model based risk assessment and audit generation in accordance with an illustrative embodiment. The example can be executed using application 200 in FIG. 2. System risk ID module 210 and role risk ID module 220 are the same as system risk ID module 210 and role risk ID module 220 in FIG. 2.

As depicted, system risk ID module 210 uses a system risk evaluation model to evaluate system data with system data attributes 310 and identify system risk 320—System A has an increasing risk trend. Role risk ID module 220 uses a role risk evaluation model to evaluate role data with role data attributes 330 and identify role risk 340—Person A.

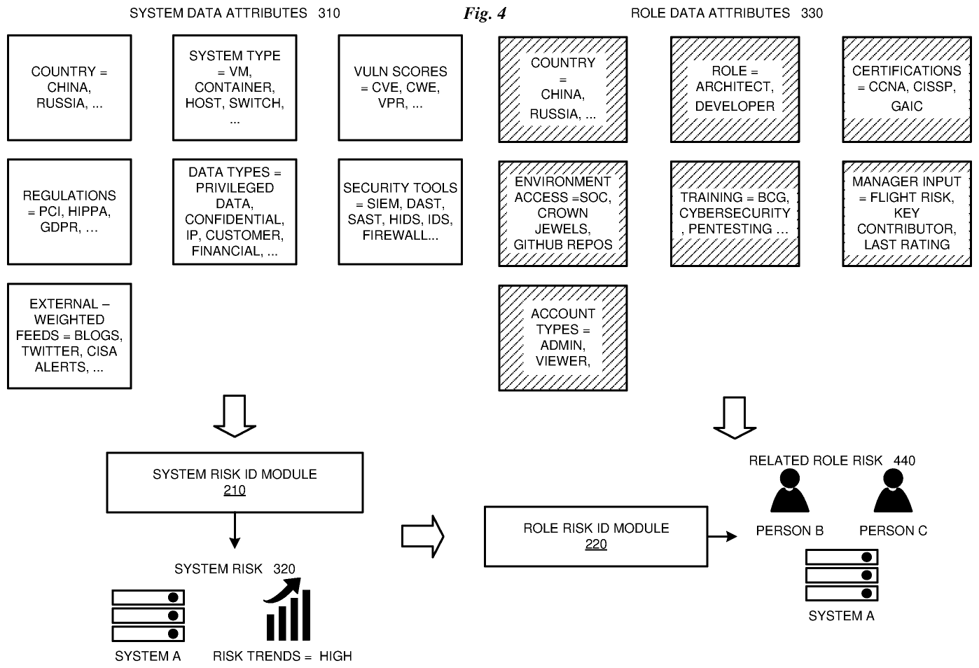

With reference to FIG. 4, this figure depicts a continued example of converged model based risk assessment and audit generation in accordance with an illustrative embodiment. System risk ID module 210 and role risk ID module 220 are the same as system risk ID module 210 and role risk ID module 220 in FIG. 2. System data attributes 310, system risk 320, and role data attributes 330 are the same as system data attributes 310, system risk 320, and role data attributes 330 in FIG. 3.

Here, system risk ID module 210 uses a system risk evaluation model to evaluate system data with system data attributes 310 and identify system risk 320—System A has an increasing risk trend. Role risk ID module 220 uses system risk 320 and the role risk evaluation model to identify related role risk 440—here, Persons B and C, associated with System A.

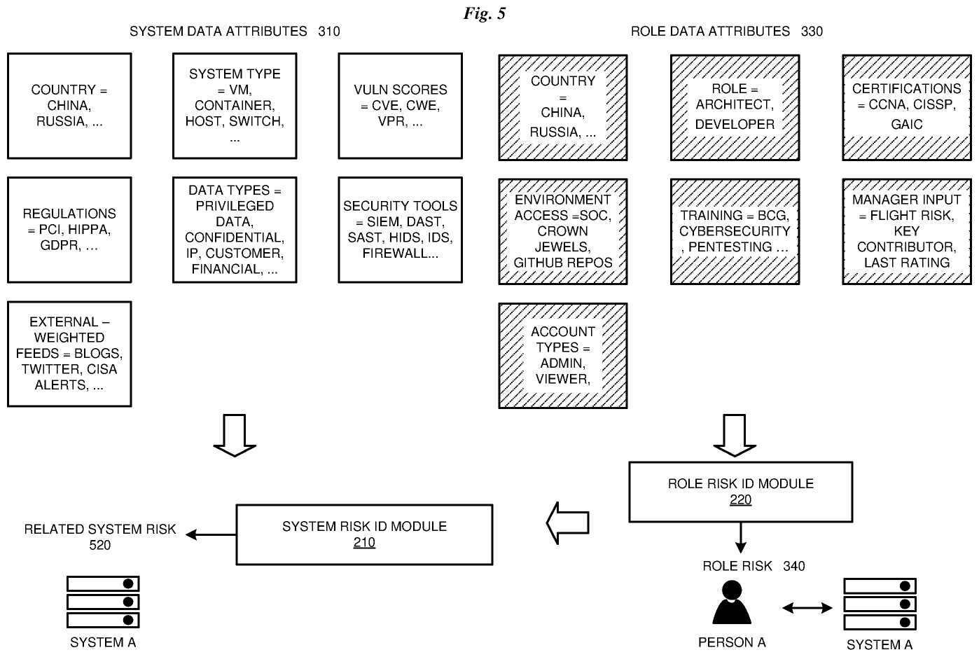

With reference to FIG. 5, this figure depicts a continued example of converged model based risk assessment and audit generation in accordance with an illustrative embodiment. System risk ID module 210 and role risk ID module 220 are the same as system risk ID module 210 and role risk ID module 220 in FIG. 2. System data attributes 310, role data attributes 330, and role risk 340 are the same as system data attributes 310, role data attributes 330, and role risk 340 in FIG. 3.

Here, role risk ID module 220 uses a role risk evaluation model to evaluate role data with role data attributes 330 and identify role risk 340—Person A, who works on System A. System risk ID module 210 uses role risk 340 and the system risk evaluation model to identify related system risk 520—System A, because Person A works on System A.

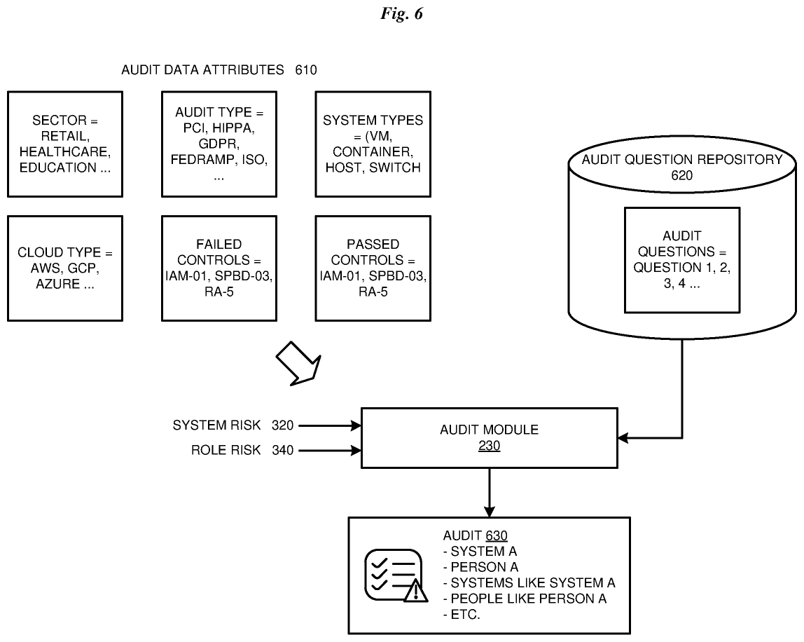

With reference to FIG. 6, this figure depicts a continued example of converged model based risk assessment and audit generation in accordance with an illustrative embodiment. Audit module 230 is the same as audit module 230 in FIG. 2. System risk 320 and role risk 340 are the same as system risk 320 and role risk 340 in FIG. 3.

As depicted, audit module 230 uses audit data with audit data attributes 610 and audit question repository 620, as well as system risk 320 and role risk 340, to generate audit 630, focusing on System A, Person A, systems like System A, and people like Person A.

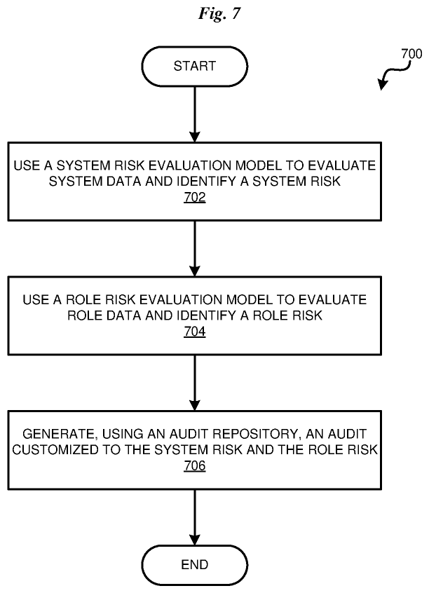

With reference to FIG. 7, this figure depicts a flowchart of an example process for converged model based risk assessment and audit generation in accordance with an illustrative embodiment. Process 700 can be implemented in application 200 in FIG. 2.

In block 702, the application uses a system risk evaluation model to evaluate system data and identify a system risk. In block 704, the application uses a role risk evaluation model to evaluate role data and identify a role risk. In block 706, the application generates, using an audit repository, an audit customized to the system risk and the role risk. Then the application ends.

Thus, a computer implemented method, system or apparatus, and computer program product are provided in the illustrative embodiments for converged model based risk assessment and audit generation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
evaluating, using a system risk evaluation model, system data, the evaluating identifying a system risk, the system risk comprising a risk associated with a system of an organization being audited, the system risk evaluation model computing a system risk score using a first plurality of weights assigned to data attributes of the system data;
evaluating, using a role risk evaluation model, role data, the evaluating identifying a role risk, the role risk comprising a risk associated with a role in the organization being audited, the role risk evaluation model comprising computing a role risk score using a second plurality of weights assigned to data attributes of the role data;
generating, using an audit repository, an audit customized to the system risk and the role risk; and
causing adjusting, using a result of the audit, a configuration of the system.

2. The computer-implemented method of claim 1, further comprising:
evaluating, using the role risk and the system risk evaluation model, the system data, the evaluating identifying a second system risk related to the role risk.

3. The computer-implemented method of claim 1, further comprising:
evaluating, using the system risk and the role risk evaluation model, the role data, the evaluating identifying a second role risk related to the system risk.

4. The computer-implemented method of claim 1, further comprising:
evaluating, using the system risk evaluation model, a subset of the system data, the subset comprising system data having attributes used by the system risk evaluation model in determining the system risk, the evaluating identifying a third system risk.

5. The computer-implemented method of claim 1, further comprising:
evaluating, using the role risk evaluation model, a subset of the role data, the subset comprising role data having attributes used by the role risk evaluation model in determining the role risk, the evaluating identifying a third role risk.

6. The computer-implemented method of claim 1, further comprising:
performing the audit.

7. The computer-implemented method of claim 1, further comprising:
updating, based on the system risk, weights of attributes used in determining the system risk, the updating resulting in an updated system risk evaluation model;
evaluating, using the updated system risk evaluation model, the system data, the evaluating identifying a new system risk; and
generating, using the audit repository, a second audit customized to the new system risk and the role risk.

8. A computer program product comprising one or more computer readable storage medium, and program instructions collectively stored on the one or more computer readable storage medium, the program instructions executable by a processor to cause the processor to perform operations comprising:
evaluating, using a system risk evaluation model, system data, the evaluating identifying a system risk, the system risk comprising a risk associated with a system of an organization being audited, the system risk evaluation model computing a system risk score using a first plurality of weights assigned to data attributes of the system data;
evaluating, using a role risk evaluation model, role data, the evaluating identifying a role risk, the role risk comprising a risk associated with a role in the organization being audited, the role risk evaluation model comprising computing a role risk score using a second plurality of weights assigned to data attributes of the role data;
generating, using an audit repository, an audit customized to the system risk and the role risk; and
causing adjusting, using a result of the audit, a configuration of the system.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, further comprising:
evaluating, using the role risk and the system risk evaluation model, the system data, the evaluating identifying a second system risk related to the role risk.

12. The computer program product of claim 8, further comprising:
evaluating, using the system risk and the role risk evaluation model, the role data, the evaluating identifying a second role risk related to the system risk.

13. The computer program product of claim 8, further comprising:
evaluating, using the system risk evaluation model, a subset of the system data, the subset comprising system data having attributes used by the system risk evaluation model in determining the system risk, the evaluating identifying a third system risk.

14. The computer program product of claim 8, further comprising:
evaluating, using the role risk evaluation model, a subset of the role data, the subset comprising role data having attributes used by the role risk evaluation model in determining the role risk, the evaluating identifying a third role risk.

15. The computer program product of claim 8, further comprising:
performing the audit.

16. The computer program product of claim 8, further comprising:
updating, based on the system risk, weights of attributes used in determining the system risk, the updating resulting in an updated system risk evaluation model;
evaluating, using the updated system risk evaluation model, the system data, the evaluating identifying a new system risk; and
generating, using the audit repository, a second audit customized to the new system risk and the role risk.

17. A computer system comprising a processor and one or more computer readable storage media, and program instructions collectively stored on the one or more computer readable storage media, the program instructions executable by the processor to cause the processor to perform operations comprising:
evaluating, using a system risk evaluation model, system data, the evaluating identifying a system risk, the system risk comprising a risk associated with a system of an organization being audited, the system risk evaluation model computing a system risk score using a first plurality of weights assigned to data attributes of the system data;
evaluating, using a role risk evaluation model, role data, the evaluating identifying a role risk, the role risk comprising a risk associated with a role in the organization being audited, the role risk evaluation model comprising computing a role risk score using a second plurality of weights assigned to data attributes of the role data;
generating, using an audit repository, an audit customized to the system risk and the role risk; and
causing adjusting, using a result of the audit, a configuration of the system.

18. The computer system of claim 17, evaluating, using the role risk and the system risk evaluation model, the system data, the evaluating identifying a second system risk related to the role risk.

19. The computer system of claim 17, evaluating, using the system risk and the role risk evaluation model, the role data, the evaluating identifying a second role risk related to the system risk.

20. The computer system of claim 17, evaluating, using the system risk evaluation model, a subset of the system data, the subset comprising system data having attributes used by the system risk evaluation model in determining the system risk, the evaluating identifying a third system risk.
